(19) United States
(12) Patent Application Publication
(10) Pub. No.: US 2006/0164711 A1
(43) Pub. Date: Jul. 27, 2006

(54) System and method utilizing an electrooptic modulator

(75) Inventors: Pradeep K. Govil, Norwalk, CT (US); James G. Tsacoyeanes, Southbury, CT (US)

Correspondence Address: STERNE, KESSLER, GOLDSTEIN & FOX PLLC, 1100 NEW YORK AVENUE, N.W., WASHINGTON, DC, 20005, US

(73) Assignee: ASML Holding N.V., Veldhoven (NL)

(21) Appl. No.: 11/039,900

(22) Filed: Jan. 24, 2005

(51) Int. Cl. G02F 1/01

(52) U.S. Cl. 359/239

(57) ABSTRACT

A system and method utilize an array of dynamically controllable optical elements to adjust one or more portions of a beam propagating therethrough. For example, the adjustments can be to change a ratio of horizontally and vertically polarized light in the portions of the beam. The adjustments can be made through application of an appropriate electric field to each of the optical elements, which forms an electrooptic modulator. In one example, a polarizer/analyzer is positioned after the array, such that only desired orientations are transmitted. The polarizing provides a desired light intensity profile, which can, for example, make the intensity inform across the beam or be used to partially or fully attenuate (e.g., block) the beam.

### CROSS REFERENCE TO RELATED APPLICATIONS

This application is related to U.S. Ser. Nos. 10/972,582, filed Oct. 26, 2004, and 11/005,222, filed Dec. 7, 2004, which are both incorporated by reference herein in their entireties.

### BACKGROUND

1. Field of the Invention

The present invention is related to electrooptic modulators.

2. Background Art

In a pattern generating environment that patterns an impinging beam of radiation, which is later projected onto an object, controlling characteristics of the illumination beam of radiation and/or the patterned beam is critical. This is because in order to form accurate patterns on the object, the beam and/or the patterned beam have to be precisely controlled.

Generally, patterning systems use static optical systems, which are typically designed and manufactured for each application in order to produce the light beams with desired characteristics. In the static optical system example, when a change in illumination characteristics is desired or needed, a new optical system must be designed and manufactured, which is costly in terms of money and time. Also, as an output of an illumination source changes with time, this cannot normally be accounted for, which can result in less than desirable results.

Current methods for uniformity control in illuminators fall into two general classes: static and dynamic control. For example, a Unicom (uniformity correction module) can be used to correct for low frequency uniformity variations. In another example, a Dynamically Adjustable Slit (DYAS) is used to correct uniformity variations of spatial frequencies up to about 0.5 mm, which also has the capability of correcting dynamically while scanning. The DYAS can be used for adjusting the illumination uniformity by use of opaque fingers to trim the light in the field plane.

Currently there are several limitations to methods of correcting for uniformity variations. The first is that at the plane that the uniformity control is applied, the techniques so far block light from the edges as opposed to the entire illumination area in that plane. This results in ellipticity and telecentricity errors. Secondly, mechanical means of correcting uniformity variations are limited by space constraints, robustness, and a limited number of actuators that are feasible.

One current method for controlling pupil fill uniformity and ellipticity use a pupilcom. The Pupicom (pupil correction module) was designed to be implemented in a rod based illuminator. Pupicom is not able to correct for full balance and has a limited range.

Another current method for controlling pupil fill uses a cleanup aperture for precise control of the illuminator NA (numerical aperture). Another issue involves incorporating cleanup apertures for off axis illumination conditions, which requires a different aperture for each application.

Therefore, what is needed is a system and method that more effectively and efficiently provides illumination uniformity, pupil fill, and/or clean up aperture control.

### SUMMARY

According to one embodiment of the present invention, a system includes an electro-optical modulator for use in a lithography tool. The system comprises at least one optical element that receives an input light beam and produces at least one output beam having a changed polarization state, at least one pair of electrodes coupled to the at least one optical element, and a control system that applies electrical signals to the at least one pair of electrodes. The application of the electrical signals produces the changed polarization state of the at least one output beam.

According to one embodiment of the present invention, there is provided a method for using an electro-optical modulator in a lithography tool. The method comprises the following steps. Changing a polarization state of an input beam to produce at least one output beam using at least one optical element. Coupling at least one pair of electrodes to at least one optical element. Controlling electrical signals transmitted to at least one pair of electrodes using a control system. The application of the electrical signals produces the changed polarization state of the at least one output beam.

Another embodiment of the present invention provides a system comprising an array of dynamically controllable optical elements, a generator, and a feedback system. The generator generates an electric field that is applied to the array of dynamic controllable optical elements. The feedback system detects at least a part of a beam that has propagated through the array of dynamically controllable optical elements and generates a control signal thereform. The electrical field is generated based on the control signal, such that the applied electrical field changes index of refraction in at least one direction in one or more dynamically controllable optical elements in the array of dynamically controllable optical elements to control polarization of the beam.

A further embodiment of the present invention provides a method, comprising the following steps. Changing an index of refraction within each optical element in array of dynamically controllable optical elements using respective electric fields applied to each of the optical elements. Changing a polarization state of respective portions of a beam propagating through each of the optical elements based on the changing of the index of refraction. Detecting each of the portions of the beam after the polarization changing step. Adjusting the applied electric fields based on the detecting step.

In one example of this embodiment, the method also comprises patterning the beam of radiation using a pattern generator and projecting the patterned beam onto a target portion of a substrate.

Another embodiment of the present invention provides a method comprising the following steps. Patterning the beam of radiation using a pattern generator. Projecting the patterned beam towards a target portion of a substrate. Changing an index of refraction within each optical element in array of dynamically controllable optical elements using respective electric fields applied to each of the optical elements. Changing a polarization state of respective portions of the projected patterned beam propagating through each of the optical elements based on the changing of the index of refraction. Detecting each of the portions of the projected patterned beam after the polarization changing step. Adjusting the applied electric fields based on the detecting step.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 shows an electrooptic modulator, according to one embodiment of the present invention.

FIGS. 2, 3, 4A, 4B, and 4C show arrays of electrooptic modulators, according to various embodiments of the present invention.

FIGS. 5, 6, and 7 show various arrangements of electrodes on an electrooptic modulator, according to various embodiments of the present invention.

FIG. 8 shows a light intensity uniformity system, according to one embodiment of the present invention.

FIGS. 9, 10, and 11 show various lithography systems having an electrooptic modulator therein, according to various embodiments of the present invention.

FIGS. 12, 13, and 14 show flowcharts depicting methods, according to various embodiments of the present invention.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

Embodiments of the present invention provide a system and method utilizing an array of dynamically controllable optical elements that are used to adjust one or more portions of a beam propagating therethrough. For example, the adjustments can be to change a ratio of horizontally and vertically polarized light in the portions of the beam. The adjustments can be made through application of an appropriate electric field to each of the optical elements, which forms an electrooptic modulator. In one example, a polarizer/analyzer is positioned after the array, such that only desired orientations are transmitted. The polarizing provides a desired light intensity profile, which can, for example, make the intensity uninform across the beam or be used to partially or fully attenuate (e.g., block) the beam. In various examples, the light characteristics can be adjusted either locally (e.g., at desired locations within a field) or globally (e.g., across the entire field).

Exemplary Electrooptic Modulators

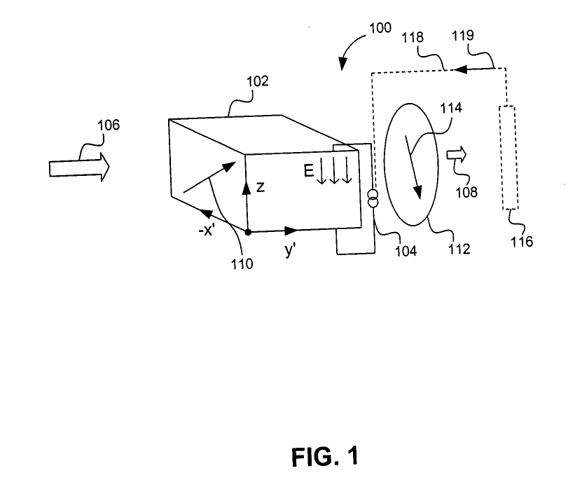

FIG. 1 shows system 100 that includes an optical element 102 receiving an electric field E from a generator 104. Although shown parallel to the Z axis, electric field E could also be parallel to the x′ axis (e.g., into the page) or parallel to the y′ axis through appropriate placement of generator 104. These and other configurations are contemplated within the scope of the present invention. In the example shown, the electric field is perpendicular to a direction of propagation of a beam of radiation 106 through optical element 102. A corner of optical element 102 shows an orientation of optical element 102 in the X, Y, and Z directions. Application of the electrical field to optical element 102 forms an electrooptic modulator, which in this embodiment can be used to modulate polarization state of beam 106 with a given polarization state to produce a polarization modulated output beam 108. A wave front or phases of components of beam 106 along the x′ and z directions are modulated by changing the indices of refraction in those directions through the applied electric field. Thus, a ratio of beam 106 that is horizontally to vertically polarized can be changed based on the application of the electric field.

In various examples, an amount of rotation of a orientation of beam 106 performed by optical element 102 can be based on either voltage applied, thickness of a crystal, or both. For example, if a thickness of optical element is fixed, and voltage is varied, varying rotations of polarizations are achieved.

In one example, a polarizer 112 is placed after optical element 102. In this example, a polarization of beam 106, which is initially polarized as shown by arrow 110, is polarized/filtered using polarizer 112, which orients output beam 108 in the direction of arrow 114. With polarizer 112 oriented as shown, an intensity of beam 106 will change depending on the incident polarization, which is controlled by generator 104. In one example, depending on an orientation of polarizer 112, light impinging on polarizer 112 can be attenuated from 0-100%.

In this embodiment, system 100 is a transverse electrooptic amplitude modulator. It is to be appreciated, that in an alternative embodiment system 100 can also be made that operate as longitudinal amplitude modulator.

In one example, system 100 also includes a control system including a detector 116 and a feedback path 118. Output beam 108 is received on the detector 116, which generates a control signal 119 transmitted through feedback path 118 to generator 104. In this example, output beam 108 can be adjusted until it is of a desired tolerance.

When system 100 is placed in a lithography system, as described below, detector 116 can be placed at various locations within the lithography system, as also discussed below.

It is to be appreciated that other arrangements of optical elements and generators can also be used to form an electrooptic modulator, for example as is described in U.S. Ser. No. 10/972,582, filed Oct. 26, 2004, entitled “System and Method Utilizing an Electrooptical Modulator,” which is incorporated by reference herein in its entirety.

In one example, optical element 102 is a crystal material. For example, one crystal material that can be used is Lithium Triborate (LiB₃O₅) (LBO) manufactured by EKSMA Co. of Vilnius, Lithuania. In other examples, potassium dihydrogen phosphate (KH₂PO₄) (also known as KDP), or ammonium dihydrogen phosphate (NH₄H₂PO₄) (also known as ADP) can be used, which exhibit similar electrooptic characteristics to LBO, but have lower transmission efficiency than LBO. However, other known materials can also be used without departing from the scope of the present invention.

In the above embodiment, electrooptic modulator 100 makes use of the linear electrooptic effect, which results from a change in the indices of refraction in different directions in an optical element (e.g., a crystal) due to an applied electric field. The effect exists only in crystals that do not possess inversion symmetry. This can be expressed in an index of ellipsoid equation, which expresses the change in anisotropy of a crystal with the electric field. The equation below describes the general form for the equation of the index of ellipsoid for an arbitrarily chosen orthogonal coordinate system in a crystal as:

$${( \frac{1}{{n}^{2}} )}_{1} {x}^{2} + {( \frac{1}{{n}^{2}} )}_{2} {y}^{2} + {( \frac{1}{{n}^{2}} )}_{3} {z}^{2} + 2 {( \frac{1}{{n}^{2}} )}_{4} yz + 2 {( \frac{1}{{n}^{2}} )}_{5} xz + 2 {( \frac{1}{{n}^{2}} )}_{6} xy = 1$$

Where n is the constant for the index of refraction for a material being used.

The change in index of refraction (n) due to an applied electric field (E) can be expressed in the matrix form as:

$$[ \begin{matrix}{Δ ( \frac{1}{{n}^{2}} )}_{1} \\ {Δ ( \frac{1}{{n}^{2}} )}_{2} \\ {Δ ( \frac{1}{{n}^{2}} )}_{3} \\ {Δ ( \frac{1}{{n}^{2}} )}_{4} \\ {Δ ( \frac{1}{{n}^{2}} )}_{5} \\ {Δ ( \frac{1}{{n}^{2}} )}_{6}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33} \\ {r}_{41} & {r}_{42} & {r}_{43} \\ {r}_{51} & {r}_{52} & {r}_{53} \\ {r}_{61} & {r}_{62} & {r}_{63}\end{matrix} ] [ \begin{matrix}{E}_{1} \\ {E}_{2} \\ {E}_{3}\end{matrix} ]$$

The second matrix in this expression is an electrooptic tensor, discussed above with respect to FIG. 1. If nonzero elements are present in this tensor, then the material exhibits the electrooptic effect.

Usually a coordinate system is determined so that equation 1 in the presence of an applied electric field reduces as follows:

$${( \frac{1}{{n}^{2}} )}_{{1}^{′}} {x}^{′2} + {( \frac{1}{{n}^{2}} )}_{{2}^{′}} {y}^{′2} + {( \frac{1}{{n}^{2}} )}_{{3}^{′}} {z}^{′2} = 1$$

Depending on the exact nature of the electrooptic tensor, a direction for the applied electric field can be determined that induces a change in the indices of refraction in perpendicular directions. Thus, the properties of the electrooptic modulator 100 are dynamically controllable because the voltage dependent index of refraction induces a retardation between the incident electric field components in the perpendicular directions. The directions chosen depend upon the symmetry properties of the crystal of interest. The retardation is proportional to the applied voltage and the corresponding electrooptic tensor component. The net effect of this is to create a voltage varying phase difference between the two directions, which can be used for different applications.

In another example, electrooptic modulator 100 placed in the pupil plane of the illuminator and/or projection optics allows for varying ellipticity in order to correct for HV bias both globally (e.g., across an entire filed in the image plane) or locally (e.g., in one or more positions within the field in the image plane).

In one example, an electrooptic system for electrooptic modulator 100 allows for very fast response times to be achieved for the correction of uniformity variations, as compared to mechanical device in conventional systems. The fast response times allow for real-time corrections during scanning to significantly improve dose uniformity.

Exemplary Arrays of Electrooptic Modulators

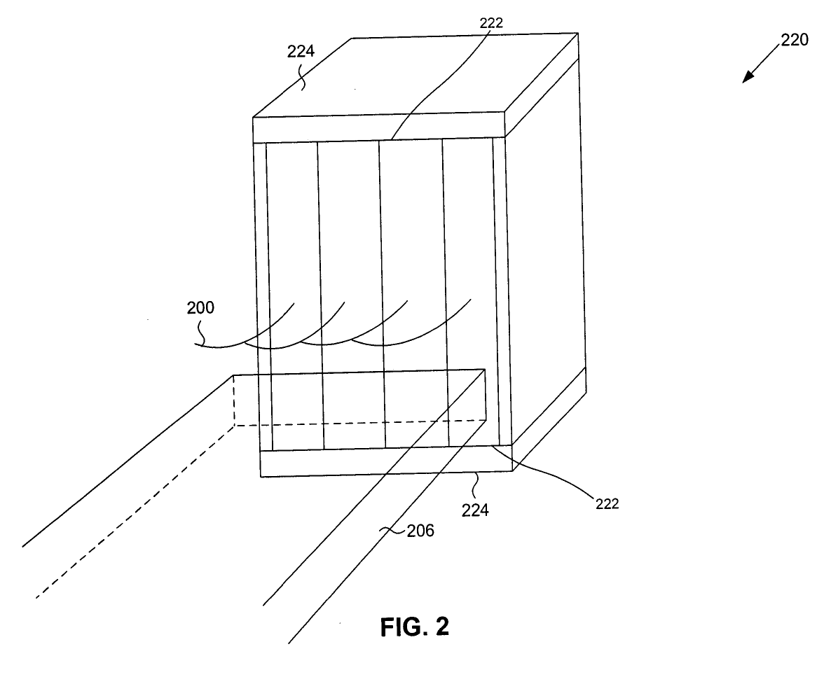

FIGS. 2, 3, and 4 show arrays 220, 320, and 420 of electrooptic modulators 200, 300, and 400, according to various embodiments of the present invention. It is to be appreciated that the number, sizes, and/or shapes of beams shown in FIGS. 2, 3, and 4 are merely exemplary, and can be different shapes and sizes, or can be multiple beams, according to various embodiments based on a specific application utilizing the arrays of electrooptic modulators.

FIG. 2 shows a 1×n (n being a positive integer greater than 1) array 220 of electrooptic modulators 200, each can be similar to modulator 100, according to one embodiment of the present invention. Each modulator 200 has electrodes 222 coupled to two, opposite sides and supports 224 coupled to two, opposite ends of modulators 200. In this perspective, electrodes 222 are vertical electrodes. This arrangement allows for single-direction modulation of a beam 206 propagating through array 220. In this example, beam 206 has a rectangular cross-section. Thus, beam 206 can be modulated in one of a X or Y direction, depending on an orientation of array 220 and electrodes 222 with respect to the cross-section of beam 206. It is to be appreciated that, although four electrooptic modulators 200 are shown, any number can be used, as is contemplated within the scope of the present invention.

In one example, electrodes can be placed vertically between optical elements 200 instead of horizontally as shown. In this way, polarization of individual portions of beam 206 can be adjusted as described above and below.

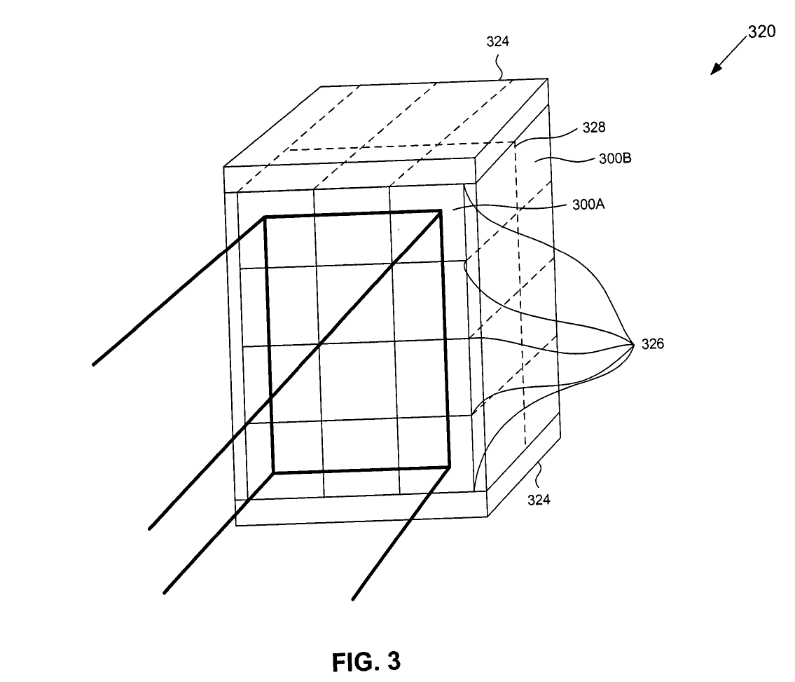

FIG. 3 shows a stacked n×m (n and m being positive integers greater than or equal to 1) array 320 of electrooptic modulators 300, each can be similar to modulator 100, according to one embodiment of the present invention. In this embodiment, a first stack, stack A, includes electrooptic modulators 300A and a second stack, stack B, includes electrooptic modulators 300B. The first and second stacks are shown as being adjacent dashed line 328. It is to be appreciated that additional stacks could also be used. With reference to elect optic modulator 100 in FIG. 1, stack A is oriented similar to electrooptic modulator 100, while electrooptic modulators 300B in stack B are rotated around the y axis 90° with respect to electrooptic modulators 300A, or vice versa

Each modulator 300 electrodes 326 coupled to two, opposite sides of. Also, array 320 includes supports 324 coupled to two, opposite ends of modulators 300. This arrangement allows for two-direction modulation of a beam 306 propagating through array 320. In this example, beam 306 has a rectangular cross-section, which can be modulated in the X and Y directions because of the orientation of array 320 and electrodes 326 with respect to the cross-section of beam 306. It is to be appreciated that, although 24 electrooptic modulators 300 are shown, any number can be used, as is contemplated within the scope of the present invention.

In one example, vertical electrodes can be used between optical elements 300 instead of horizontal electrodes.

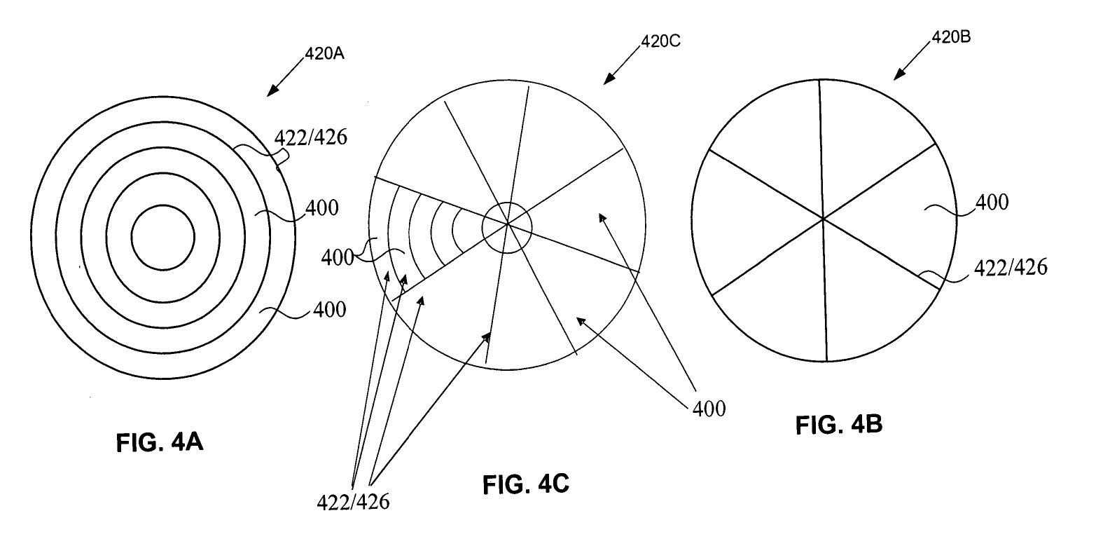

FIGS. 4A, 4B, and 4C show various arrays of electrooptic modulators 400, according to various embodiments of the present invention. These are not meant to show an exhaustive set of configurations, but only an exemplary set of configurations.

FIG. 4A shows an array 420A including annular sections, where each section is an electrooptic modulator 400. Similar to modulators 200 and 300 in arrays 220 and 320 discussed above, modulators 400 have electrodes 422/426 coupled to their sides in order to allow for the functionality discussed above. Although shown as five annular sections, any number of annular sections could be used. Also,

one or more annular sections can be used together to form a same polarization change.

FIG. 4B shows an array 420B including sectors, where each sector is an electrooptic modulator 400, according to one embodiment of the present invention. Similar to modulators 200 and 300 in arrays 220 and 320 discussed above, modulators 400 have electrodes 422/426 coupled to their sides in order to allow for the functionality discussed above. Although shown as six sectors, any number of sectors can be used, which is application specific.

FIG. 4C shows an array 420C including sectors, where one or more sectors includes one or more portions of annular sections, according to one embodiment of the present invention. In this embodiment, each sector and each annular section can be a separate electrooptic modulator 400. Similar to modulators 200 and 300 in arrays 220 and 320 discussed above, modulators 400 have electrodes 422/426 coupled to their sides in order to allow for the functionality discussed above. Any number of sectors and/or annular sections can be used.

In one example, when multiple concentric arrays can be used, electrodes can be positioned and energized so as to be able to change non-adjacent portions of a beam of radiation impinging on the array.

In one example, this arrangement allows for correction of high spatial frequency components in the uniformity variations.

In one example, the arrays operate at relative highspeeds, which allows spatial uniformity correction while scanning a field of an image plane.

In one example, polarization change is based on sectors, which allows for polarization changes to be controlled sector to sector. In the embodiments shown above in FIGS. 4A and 4C having annular rings, polarization can change ring to ring.

In one example, different configurations allow polarization to be change in different pupil positions, which determines different pole angles (e.g., width of sector, angular spread of sector) and allows for different illumination modes. For example, when quad annular sectors are used quadripole illumination mode can be effectively used. In another example, hexapole can be used, for example by selecting six rings at different radius in an annular configuration. In another example, a location or portion of annular sector is radially selected, for example, to adjust a thickness of a cumulative annular ring.

Exemplary Electrode Arrangements

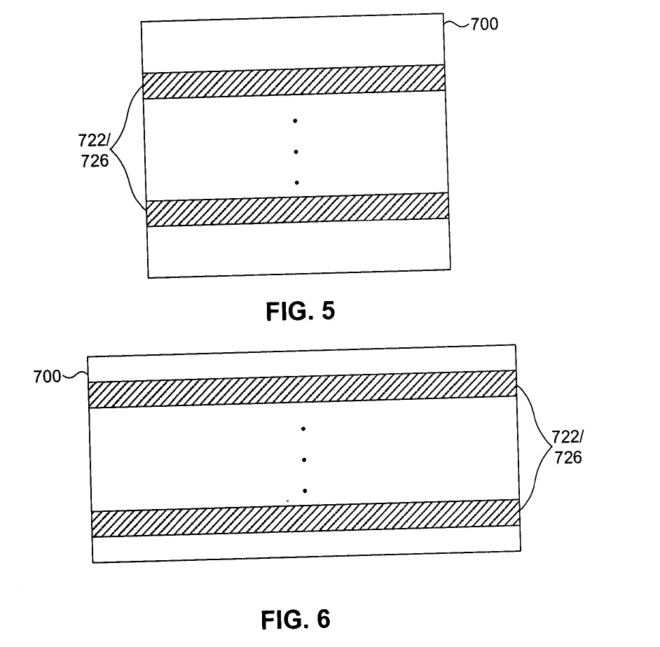

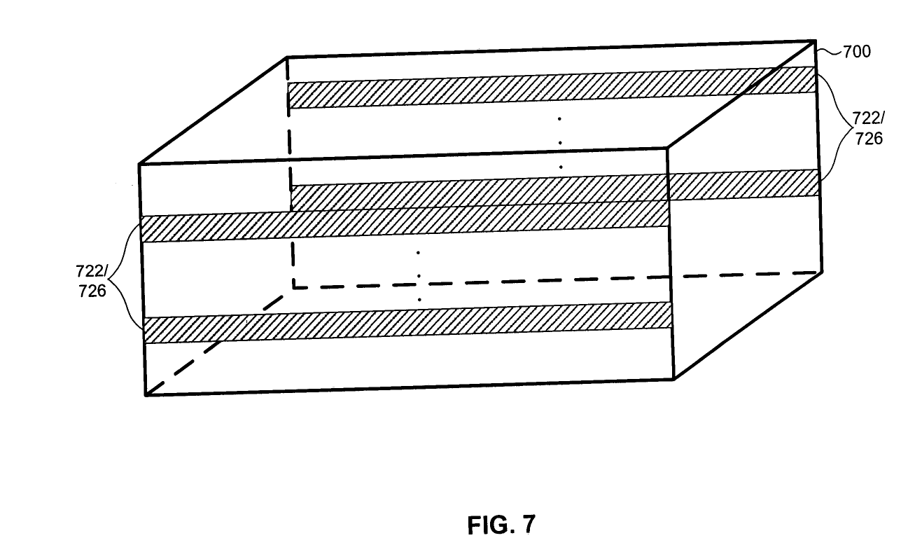

FIGS. 5, 6, and 7 show end, side, and perspective views, respectively, of various arrangements of electrodes 722/726 on an electrooptic modulator 700, according to various embodiments of the present invention. In the above described embodiments, an electrode was coupled to either two opposite sides or two sets of opposite sides of one or more electrooptic modulators. However, as shown in FIGS. 5, 6, and 7, more than one electrode 722/726 can be coupled to each side of electrooptic modulator 700. This can be done to increase controllability of one or more beams of radiation (not shown) propagating through modulator 700. Also, although shown horizontally in this perspective, vertically coupled electrodes can also be used.

Thus, through the use of electrodes 722/726 coupled in different arrangements to sides of optical element 102, or arrays of optical element 102, light propagating through optical element 102, or arrays thereof, can be very accurately controlled or modified as necessary or as desired. Thus, characteristics of the light, for example, uniformity, ellipticity, telecentricity, or the like, can be modified as needed or as desired. As discussed above and below, this can be used to control pupil fill or shape, for example, in an illumination or projection system.

It is to be appreciated that, although the above embodiments and example are discussed such that a beam is transmitted through an electrooptic modulator into an entry side and out an exit side, in other embodiments a surface opposite the entry surface can have a reflective coating, layer, substance, or material. Thus, instead of a beam being transmitted through the electrooptic modulator, it reflects from the side opposite the entry side and back out the entry side after changing its characteristics using an electric field. In other example, the reflection side may not be opposite the entry side, or the light may enter, reflect, and exit from three different sides.

Exemplary Intensity Uniformity Arrangement

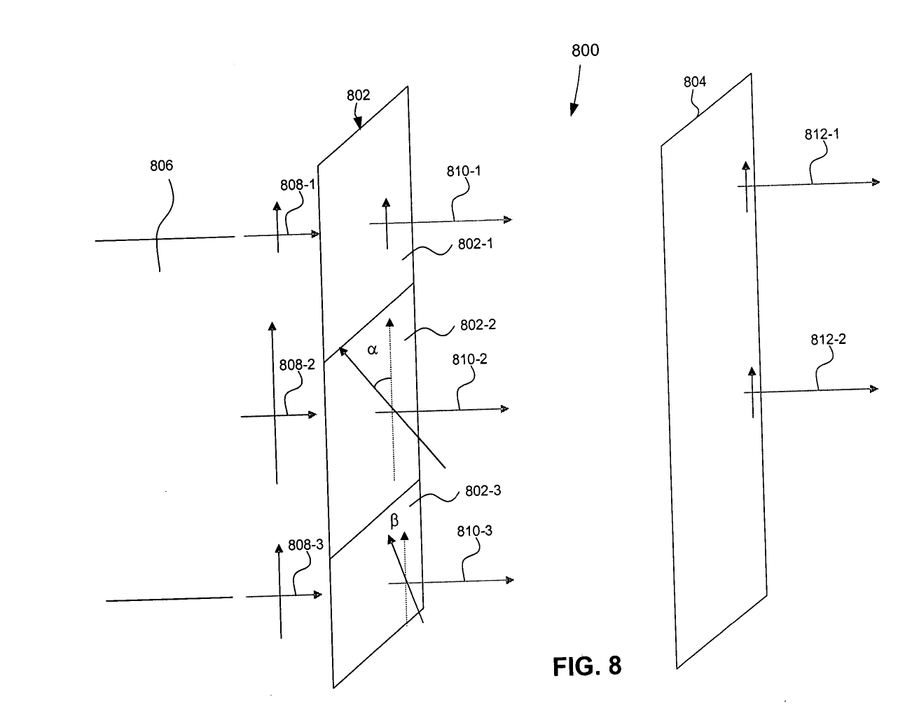

FIG. 8 shows a light intensity uniformity system 800, according to one embodiment of the present invention. System 800 includes a array of electrooptic modulators 802 and an analyzer 804 (e.g., an intensity uniformity control analyzer) (also known and referred to as a polarizer). Respective portions 806-1 to 806-n (where n is a positive integer greater than or equal to 1) of a beam of radiation 808 impinges on modulators 802. In one example, beam portions 808 of beam 806 are modified to form output beams 810-1 to 810-n. Output beams 810 impinge on polarizer 804, and may be modified to form output beams 812-1 to 812-n.

In this example, a polarization state of each input beam 808-1 to 808-n can be changed using each electrooptical modulator 802-1 to 802-n. In the example shown, polarization orientation of portion 808-1 is unchanged by modulator 802-1 to form output beam 810-1, polarization orientation of portion 808-2 is rotated through an angle α by modulator 802-2 to form output beam 810-2, and polarization orientation of portion 808-2 is rotated through an angle β to form output beam 810-3. As described above, the polarization orientation rotation is based on an amount of applied electric field. For example, this can be controlled using feedback system 116, 118, and 119.

Then, by placing polarizer 804 after array 802, only certain orientations are transmitted to form output beam 812, shown as portions 812-1 and 812-2, which in effect produces intensity modulation. Polarizer 804 transmits a particular polarization state to change intensity. For example, if beam 806 is linear in one direction, and it is desired to change intensity at one position 808-n within beam 806, that position 808-n could be made elliptical using a respective modulator 802-n. This reduces a linear component in that direction. Then, polarizer 804 only transmits light coming in at desired angles, and anything outside of that polarization angle is rejected. So, intensity of light is changed for that portion 808-n of beam 806. Thus, a final output beam 812 has a desired light intensity profile.

In one example, this allows modulation of intensity at various points 808-n in cross section of beam 806, which is done by applying different polarization states or angles through use of an array of electrooptical modulators 802-n. Then, when output beams 810-n go through polarizer 804, a variation of light intensity is seen across the cross section of beam 806 in output beam 812.

For example, if beam 806 is linear in y direction (polarization state), a change in relationship between two indices is performed using modulator 802-n since modulators 802-n become birefringent when a voltage is applied. Effectively, each portion 808-n of beam 806 into split into two components. One component travels through each modulator 802-n faster than the other component, which causes a respective output beam 810-n to be elliptically polarized. When the respective output beam 810-n travels through linear polarizer 804, one component is eliminated and the other component is reduced to correct for intensity variation in output beam 812.

In one example, beam 806 is linearly polarized, and is kept in this state until after polarizer 804. After polarizer 804, a random polarization device is used (not shown) to allow for the a beam leaving system 800 to be randomly polarized, but still have a desired intensity profile.

In one example, system 800 is located in an illumination system that produces beam 806. For example, in a lithography environment discussed below, a feedback signal is transmitted from an image plane monitor intensity of a cross section of the beam. Polarization states within the beam that need to be changed to control uniformity of the light intensity across the beam are determined, and use to control modulators 802-n. In another example, feedback can be based on light detected before light impinges a pattern generator of the lithography system.

In one example, a polarizer is not needed, and this is removed. For example, by arranging electrooptic modulation in the array with different orientations, can get output beam with different polarization states.

In one example, system 800 is positioned at an illuminator pupil to control pupil fill uniformity, ellipticity, and/or for use as a cleanup aperture. By adjusting the voltage of a generator (not specifically shown) of each modulator 802-n, the polarization state coming out of each modulator 802-n could range from the same polarization state as entering the array 802 to elliptical or a polarization state rotated 90 degrees from the incident beam. In any case, the ratio of light that is horizontally to vertically polarized can be changed for each element 802-n continuously. Polarizer 804 acts as a linear analyzer picks out the desired polarization state. The final result is a correction of the intensity of the desired pupil fill spatial frequency to the required level.

In one example, to completely eliminate undesired frequencies as is required for off-axis illumination, the polarization state would be rotated 90 degrees so that none of beam 806 passes through analyzer 804. In such a configuration, system 800 would act as a cleanup aperture.

In one example, system 800 can be placed after an optical system having at least a pupil. A sigma of the pupil can be measured, and used to control each modulator 802-n to adjust system 800 to modify a clean up aperture or numerical aperture until a desired sigma is achieved, e.g., by controlling an amount of the intensity of light.

Exemplary Environment: Lithography

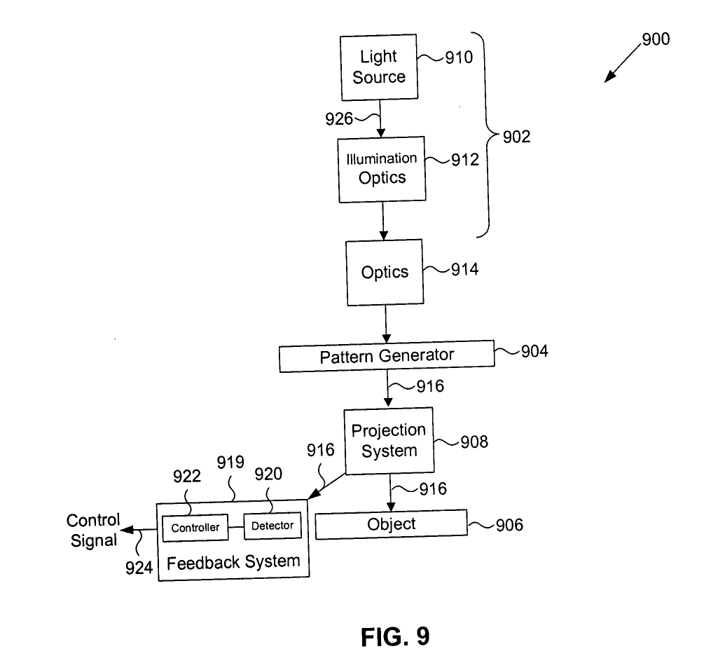

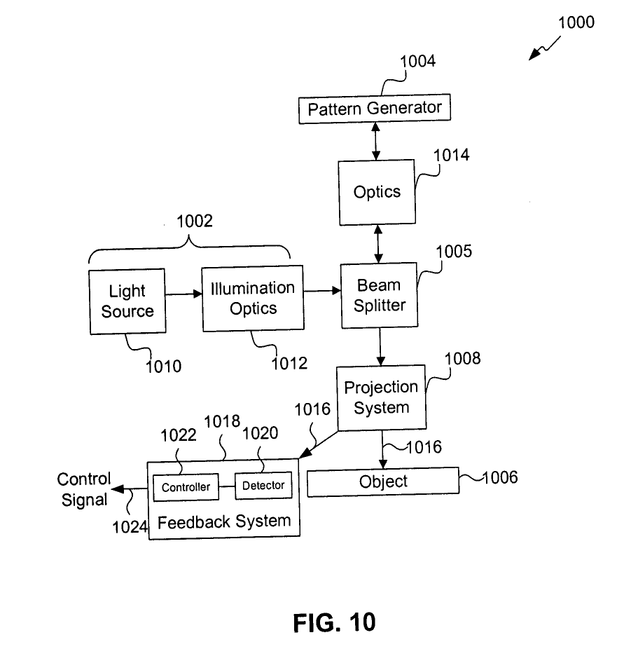

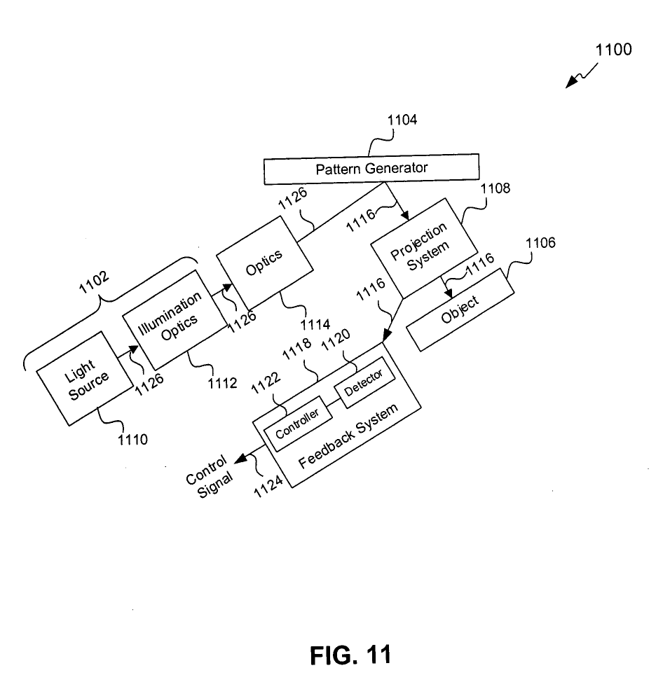

FIGS. 9, 10, and 11 show various lithography systems 900, 1000, 1100, and having an electrooptic modulator therein, according to various embodiments of the present invention. In these systems, radiation from an from an illumination system 902/1002/1102 illuminates a pattern generator 904/1004/1104 to produce patterned light, which is directed from pattern generator 904/1004/1104 towards a work piece 906/1006/1106 via a projection system 908/1008/1108.

In system 1000, light is directed to and from pattern generator 1004 via a beam splitter 1005.

In one example, patterned light 916/1016/1116 can be received at feedback system 918/1018/1118 by a detector 920/1020/1120. A signal 922/1022/1122 representative of received patterned light 916/1016/1116 is transmitted from detector 920/1020/1120 to controller 922/1022/1122, and used to produce control signal 924/1024/1124. Control signal 924/1024/1124 can be a compensation or adjustment signal based on an actual (measured) versus desired value for an optical characteristics, for example, intensity, uniformity, ellipticity, telecentricity, etc., as discussed above. For example, in the embodiment shown in FIG. 1, control signal 924 is control signal 112 received at node 110 of generator 104, which is used to dynamically control generation of an electric field E to dynamically control propagation of light beam 106 through optical element 102.

In various embodiments, work piece 906/1006/1106 is, but is not limited to, a substrate, a wafer, a flat panel display substrate, print head, micro or nano-fluidic devices, or the like.

As is known, illumination system 902/1002/1102 can include a light source 910/1010/1110 and illumination optics 912/1012/1112 and pattern generator can have optics 914/1014/1114. One or both of these optics can include one or more optical elements (e.g., lenses, mirrors, etc.). For example, one or both of the optics 912/1012/1112 can include any one of the electrooptic modulators or arrays of modulators as described above, which can be used to dynamically control illumination light 926/1026/1126 before it reaches pattern generator 904/1004/1104. This can be used to control to control one of conventional, annular, single pole, multiple pole, or quasar illumination mode.

In one example, projection system 908/1008/1108 includes one or more optical elements (e.g., lenses, mirrors, etc.). For example, projection system 908/1008/1108 can include any of the electrooptic modulators or arrays of modulators as described above, which can be used to dynamically control patterned light 916/1016/1116 before it reaches work piece 906/606/1106.

In various examples, pattern generator 904/1004/1104 can be a mask-based or maskless pattern generator, as would become apparent to one of ordinary skill in the art. The masked-based or maskless system can be associated with a lithography, photolithography, microlithography, or immersion lithography system.

For example, using an array of electrooptic modulators, such as one of those described above, in one of the lithography systems 900, 1000, or 1100, active control of uniformity variations is performed through redirecting a light distribution a reticle, which reduces an amount of light loss through varying of a voltage across each electrooptic modulator in the array.

In one example, the electrooptic modulator used in system 900, 1000, or 1100 can be used to control an angular distribution of light at either a pattern generator 904/1004/1104 or a plane in which work piece 906/1006/1106 is placed, effectively eliminating the need for different diffractive arrays for generating pupil fills.

In one example, the electrooptic modulator used in system 900, 1000, or 1100 can be used to control pupil fill or shape in projection system 908/1008/1108.

Exemplary Operation

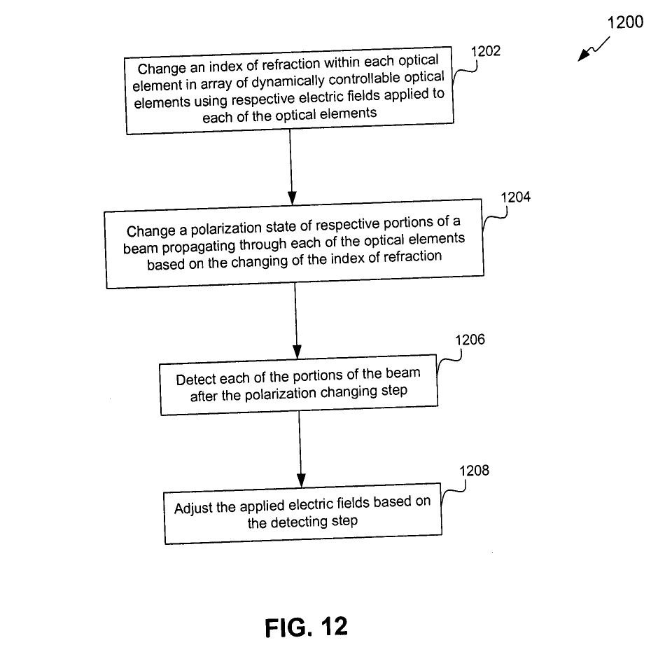

FIG. 12 show a flowchart depicting a method 1200, according to one embodiment of the present invention. In step 1202, an index of refraction is within each optical element in array of dynamically controllable optical elements is changed using respective electric fields applied to each of the optical elements. In step 1204, a polarization state of respective portions of a beam is propagating through each of the optical elements changed based on the changing of the index of refraction. In step 1206, each of the portions of the beam are detected after the polarization changing step. In step 1208, the applied electric fields are adjusted based on the detecting step.

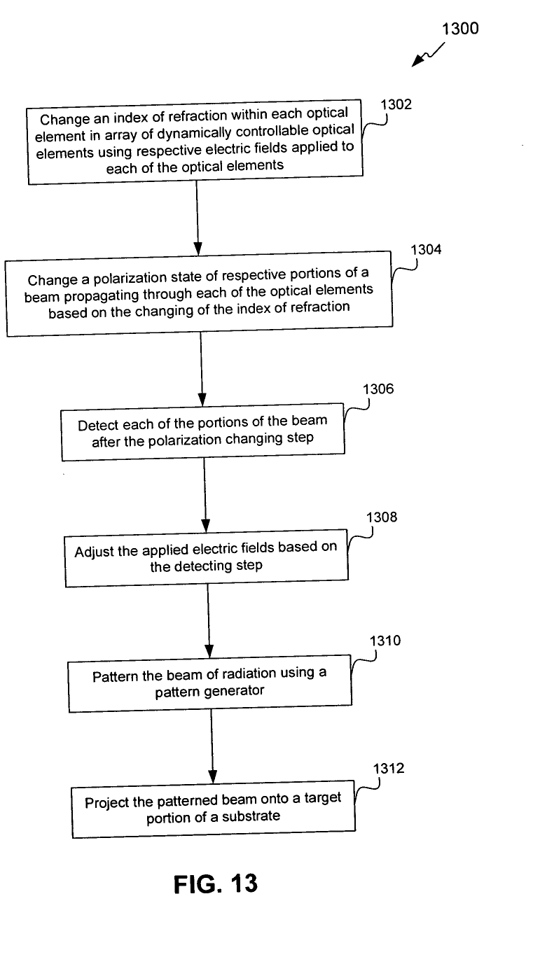

FIG. 13 shows a flowchart depicting a method 1300, according to an embodiment of the present invention. In step 1302, an index of refraction within each optical element in array of dynamically controllable optical elements is changed using respective electric fields applied to each of the optical elements. In step 1304, a polarization state of respective portions of a beam propagating through each of the optical elements is changed based on the changing of the index of refraction. In step 1306, each of the portions of the beam after the polarization changing step are detected. In step 1308, the applied electric fields are adjusted based on the detecting step. In step 1310, the beam of radiation is patterned using a pattern generator. In step 1312, the patterned beam is projected onto a target portion of a substrate.

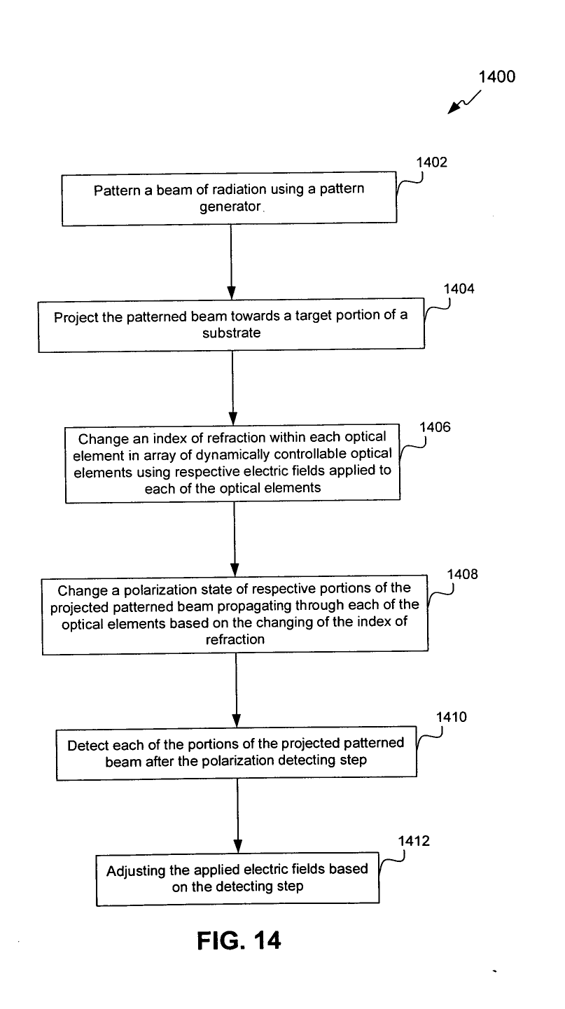

FIG. 14 shows a flowchart depicting a method 1400, according to one embodiment of the present invention. In step 1402, a beam of radiation is patterned using a pattern generator. In step 1404, the patterned beam is projected towards a target portion of a substrate. In step 1406, an index of refraction within each optical element in array of dynamically controllable optical elements is changed using respective electric fields applied to each of the optical elements. In step 1408, a polarization state of respective portions of the projected patterned beam propagating through each of the optical elements is changed based on the changing of the index of refraction. In step 1410, each of the portions of the projected patterned beam are detected after the polarization detecting step. In step 1412, the applied electric fields are adjusted based on the detecting step.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A system including an electro-optical modulator for use in a lithography tool, comprising:
at least one optical element that receives an input light beam and produces at least one output beam having a changed polarization state;
at least one pair of electrodes coupled to the at least one optical element; and
a control system that applies electrical signals to the at least one pair of electrodes,
wherein the application of the electrical signals produces the changed polarization state of the at least one output beam.

2. The system of claim 1, wherein first and second ones of the at least one pair of electrodes are used on opposite sides of the optical element, such that plural ones of the at least one output beams are produced.

3. The system of claim 1, wherein at least two of the one or more optical elements are used to produce at least two of the at least one output beam.

4. The system of claim 1, further comprising:
an illumination device that produces a beam of radiation;
a pattern generator that patterns the beam and is positioned at an object plane; and
a projection system that projects the patterned beam onto a target portion of a substrate and includes a pupil plane,
wherein the modulator is positioned in at least one of the object plane or the pupil plane.

5. The system of claim 1, further comprising:
a feedback system positioned to detect at least part of the at least one output beam and to generate a feedback signal therefrom that is transmitted to the control system.

6. The system of claim 1, further comprising:
an analyzer positioned to receive the at least one output light beam and to produce a second output beam therefrom having a uniform intensity profile.

7. The system of claim 1, further comprising:
an analyzer positioned to receive the at least one output light beam and to produce a second output beam having a desired output intensity for each of the at least one output beams.

8. The system of claim 1, further comprising:
an optical system positioned after the modulator; and
a detector that measures an actual sigma value of a pupil of the optical system and generates a control signal that is transmitted to the control system.

9. The system of claim 8, wherein the control system adjusts a clean up aperture or a numerical aperture of the optical system to produce a desired sigma value.

10. The system of claim 1, further comprising:
an array of the at least one optical elements, each of the at least one optical elements in the array being used to change the polarization state of individual portions of the at least one output beam.

11. The system of claim 1, wherein the lithography system is used to expose one of a semiconductor wafer or a flat panel display substrate.

12. Forming a flat panel display using the system of claim 1.

13. A method for using an electro-optical modulator in a lithography tool, comprising:
changing a polarization state of an input beam to produce at least one output beam using at least one optical element;
coupling at least one pair of electrodes to the at least one optical element; and
controlling electrical signals transmitted to the at least one pair of electrodes using a control system,
wherein the application of the electrical signals produces the changed polarization state of the at least one output beam.

14. The method of claim 13, further comprising:
coupling first and second ones of the at least one pair of electrodes are used on opposite sides of the optical element, such that plural ones of the at least one output beams are produced.

15. The system method of claim 13, further comprising:
using at least two of the one or more optical elements to produce at least two of the at least one output beam.

16. The method of claim 13, further comprising:
detecting at least part of the at least one output beam using a feedback system; and
generating a feedback signal from the detecting step that is transmitted to the control system.

17. The method of claim 13, further comprising:
positioning an analyzer to receive the at least one output light beam and to produce a second output beam therefrom having a uniform intensity profile.

18. The method of claim 13, further comprising:
positioning an analyzer to receive the at least one output light beam and to produce a second output beam having a desired output intensity for each of the at least one output beams.

19. The method of claim 13, further comprising:
positioning an optical system after the modulator;
measuring an actual sigma value of a pupil of the optical system; and
generating a control signal based on the measuring step that is used during the controlling step.

20. The method of claim 19, wherein the control system adjusts a clean up aperture or a numerical aperture of the optical system to produce a desired sigma value.

21. The method of claim 13, further comprising:
forming an array of the at least one optical elements, each of the at least one optical elements in the array being used to change the polarization state of individual portions of the at least one output beam.

22. The method of claim 13, further comprising using the lithography system is used to expose one of a semiconductor wafer or a flat panel display substrate.

23. Forming a flat panel display using the method of claim 22.
